(19) United States
(12) Patent Application Publication
(10) Pub. No.: US 2026/0017883 A1
(43) Pub. Date: Jan. 15, 2026

(54) SYSTEM AND METHOD OF 3D RECONSTRUCTION AND SUBREGION IMAGE STITCHING

(71) Applicant: Elm, Riyadh (SA)

(72) Inventors: Aleksei SOLOVEV, London (GB); Mohammed HAKAMI, Riyadh (SA); Thariq KHALID, Riyadh (SA); Riad SOUISSI, Riyadh (SA)

(73) Assignee: Elm, Riyadh (SA)

(21) Appl. No.: 19/263,196

(22) Filed: Jul. 8, 2025

Related U.S. Application Data
(60) Provisional application No. 63/669,061, filed on Jul. 9, 2024.

(51) Int. Cl. G06T 17/05; G06T 3/4038; G06T 7/13; G06T 7/73

(52) U.S. Cl. CPC G06T 17/05; G06T 3/4038; G06T 7/13; G06T 7/73; G06T 2207/10016; G06T 2207/10028; G06T 2207/20024; G06T 2207/20081; G06T 2207/30244; G06T 2207/30252

(57) ABSTRACT

A method and system for constructing a three-dimensional (3D) aerial survey of a city street scene include obtaining a plurality of video frames from a calibrated multi-camera setup covering a 360-degree view mounted on a moving vehicle. The plurality of video frames is split into a plurality of 3D parts containing a subset of the plurality of video frames and preprocessing the subset of the plurality of video frames of each part of the plurality of parts to obtain a calculated information. Further, constructing, by the processing circuitry, a 3D representation of each part of the plurality of parts based on the calculated information to obtain a plurality of local 3D reconstructed scene intervals. The method includes stitching and filtering, by the processing circuitry, the plurality of local 3D reconstructed scene intervals to construct the 3D city street scene.

### CROSS-REFERENCE TO RELATED APPLICATIONS

This application claims the benefit of priority to provisional application No. 63/669,061 filed Jul. 9, 2024, the entire contents of which are incorporated herein by reference.

### TECHNICAL FIELD

The present disclosure is directed to three-dimensional (3D) image reconstruction, and more particularly to a method and a system for constructing a three-dimensional (3D) aerial survey of a city street scene.

### DESCRIPTION OF RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Urban development and architectural visualization increasingly rely on digital modelling techniques to simulate real-world environments. In recent years, there has been a significant advancement in the field of 3D reconstruction, driven by the availability of data sources, such as aerial imagery, LiDAR point clouds, and street-level images. The three-dimensional (3D) modeling technologies has now become an essential tool in areas such as urban planning, architecture, traffic simulation and virtual reality as traditional two-dimensional (2D) maps and blueprints are limited in their capacity to accurately represent the complexity and spatial relationships inherent in real-world environments.

The traditional methods for 3D reconstruction, such as those based on photogrammetry and computer vision, are often resource-intensive, requiring significant time and manual effort. However, recent advancements in deep learning techniques, coupled with the availability of large-scale datasets, have enabled the development of more efficient and accurate approaches for city-scale 3D reconstruction.

Despite significant progress made in the field of 3D reconstruction, several challenges still remain. One of the major challenges is the ability to reconstruct large-scale 3D models of urban environments while maintaining both high accuracy and computational efficiency.

Additionally, the presence of intermittent or transient objects, such as moving vehicles, roads, buildings, pedestrians pathways, vegetation or temporary structures, poses a challenge, as these elements should be excluded from a final digital twin to ensure a clean and consistent representation of the static urban environment.

In one conventional approach, 3D Gaussian Splatting (3DGS) has been described, which represents the geometry and appearance via a set of 3D Gaussians, defined by position, covariance, opacity, and spherical harmonics. The Gaussians are projected into 2D space, tiled, sorted, and alpha-blended for rendering. While enabling high-quality, view-dependent rendering, the 3DGS lacks explicit surface geometry, leading to limitations in structural analysis, high computational costs, and poor compatibility with standard 3D formats.

In another conventional approach, the FastGaussian method partitions large scenes into multiple cells using an airspace-aware visibility criterion and decouples appearance modeling during optimization to reduce floaters, enabling real-time rendering post-optimization. While effective for aerial data, it struggles with dynamic scenes, requires high storage for large environments, and slows down as scene size increases.

In yet another conventional approach, street view synthesis is addressed using the 3D Gaussian Splatting (3DGS) combined with a customized diffusion model, treating the task as a sparse-view reconstruction problem. The diffusion model provides pseudo-view regularization to guide the 3DGS training. While effective for fixed-camera vehicle scenarios, the method involves time-intensive training, limiting scalability and operational efficiency.

In another conventional approach, a computer vision technique referred to as Neural Radiance Fields (NeRF) enables photorealistic scene synthesis from arbitrary viewpoints by training a neural network on images and corresponding camera poses. The network learns a continuous volumetric representation based on 3D coordinates and viewing directions. However, updating or expanding the scene requires full retraining of the neural network, resulting in time-intensive processing, limited scalability, and increased hardware demands.

In another approach, MegaNeRF, S3 Gaussian, Block-NeRF are considered as they are the advanced methods for large-scale 3D scene reconstruction. The MegaNeRF's block-wise training causes high resource usage and boundary artifacts. The S3 Gaussian's complex design limits scalability and introduces noise due to missing annotations. The Block-NeRF lacks flexibility for dynamic scenes and suffers from transition artifacts and redundant computations.

The traditional approaches to 3D scene reconstruction and rendering each present specific limitations. 3D Gaussian Splatting (3DGS) offers view-dependent rendering but lacks explicit geometry and is resource-intensive. FastGaussian enhances real-time performance through partitioning but cannot be used in dynamic scenes and large environments. Diffusion-guided 3DGS improves sparse-view synthesis but is slow to train. NeRF provides photorealism but lacks adaptability due to retraining needs. Scalable methods like MegaNeRF, S3 Gaussian, and Block-NeRF support large-scale scenes but suffer from high computational demands, noise, and limited dynamic scene handling.

Accordingly, it is one object of the present disclosure to provide a system and a method that can overcome the limitations of the prior arts. Another object is a system and method that can reconstruct 3D models of cities at a large scale, while maintaining accuracy and efficiency. Another object is a system and method to remove intermittent objects in a final digital twin.

### SUMMARY

In an exemplary embodiment, a method of constructing a three-dimensional (3D) model of an urban area is disclosed. The method includes obtaining a plurality of video frames from a calibrated multi-camera setup covering a 360-degree view mounted on a vehicle, wherein the plurality of video frames is obtained while the vehicle is moving through the urban area. The method includes splitting, by processing circuitry, the plurality of video frames into a plurality of 3D parts containing a subset of the plurality of video frames. The method includes preprocessing, by the processing circuitry, the subset of the plurality of video frames of each part of the plurality of parts to obtain a calculated information. The method includes constructing, by the processing circuitry, a 3D representation of each part of the plurality of parts based on the calculated information to obtain a plurality of local 3D reconstructed scene intervals. The method further includes stitching and filtering, by the processing circuitry, the plurality of local 3D reconstructed scene intervals to construct a 3D digital twin, and periodically transmit and store the digital twin in a database as a 3D model of the urban area.

In some embodiments, the preprocessing further includes identifying, by the processing circuitry, a plurality of objects to be excluded based on a scene reconstruction framework having a prompt-based video segmentation module, an object detection model, and a tracking foundation model from the subset of the plurality of video frames of each part of the plurality of parts; and removing, by the processing circuitry, the plurality of objects to be excluded and reconstructing the plurality of video frames based on a video inpainting model.

In some embodiments, the preprocessing further includes estimating, by the processing circuitry, camera poses, and a point cloud based on a structure-from-motion (SfM) approach, wherein distinctive features, including corners or edges, are extracted from each image; training, by the processing circuitry, a view synthesis model with the camera poses and the point cloud; and obtaining the calculated information based on the view synthesis model.

In some embodiments, the constructing includes refining, by the processing circuitry, the plurality of local 3D reconstructed scene intervals based on a bundle adjustment technique, wherein the bundle adjustment technique is a non-linear least-squares optimization.

In some embodiments, the stitching and filtering includes converting, by the processing circuitry, a local coordinate each local 3D reconstructed scene interval of the plurality of local 3D reconstructed scene intervals represented by an ellipsoid based on a Kabsch-Umeyama algorithm to obtain a structure-from-motion (SfM) coordinate and calculating, by the processing circuitry, a hyperplane between two adjacent local 3D reconstructed scene intervals of the plurality of local 3D reconstructed scene intervals.

In some embodiments, the stitching and filtering further include filtering, by the processing circuitry, a noise based on the hyperplane to obtain a plurality of filtered local 3D reconstructed scene intervals.

In some embodiments, the stitching and filtering further include stitching, by the processing circuitry, the plurality of filtered local 3D reconstructed scene intervals to construct the 3D city street scene.

In some embodiments, the splitting includes dividing the plurality of video frames into one timestamp to create the plurality of parts of equal-size and training in a parallel processing pipeline, models based on Gaussian Splitting (GS) and neural radiance field (NeRF) with normalized said camera poses and a point cloud from SfM, supervised by segmentation masks and depth maps.

In some embodiments, the stitching includes merging and aligning local Gaussian point cloud scenes and building a large-scale level digital twin of the 3D city street scene, leveraging transforms that are calculated via intersections of the camera poses over a shared timestamp for neighboring of the 3D parts.

In some embodiments, the method further includes constructing 3D city street scenes into a virtual reality application.

In another exemplary embodiment, a system for constructing a three-dimensional (3D) model of an urban area is disclosed. The system includes a calibrated multi-camera setup covering a 360-degree view mounted on a vehicle configured to obtain a plurality of video frames while the vehicle is traveling through the urban area. The system further includes a processing circuitry configured to split the plurality of video frames into a plurality of 3D parts containing a subset of the plurality of video frames. The processing circuitry is also configured to preprocesses the subset of the plurality of video frames of each part of the plurality of parts to obtain a calculated information and construct a 3D representation of each part of the plurality of parts based on the calculated information to obtain a plurality of local 3D reconstructed scene intervals. The processing circuitry is further configured to stitch and filter the plurality of local 3D reconstructed scene intervals to construct a 3D digital twin, and periodically transmit and store the digital twin in a database as a 3D model of the urban area.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary representation of an environment comprising a system for constructing a three-dimensional (3D) aerial survey of a city street scene, according to certain embodiments.

FIG. 2 is an exemplary pictorial representation depicting a calibrated camera setup for constructing the 3D aerial survey of the city street scene, according to certain embodiments.

FIG. 3 illustrates a schematic block diagram representation of a 3D aerial survey construction process followed by the system of FIG. 1 for constructing the 3D aerial survey of the city street scene, according to certain embodiments.

FIG. 4 illustrates a schematic block diagram representation of a preprocessing process followed by the system of FIG. 1 for preprocessing videos, according to certain embodiments.

FIG. 5 illustrates a schematic block diagram representation of a stitching and filtering process followed by the system of FIG. 1 for constructing the 3D aerial survey of the city street scene, according to certain embodiments.

FIG. 6 is an exemplary pictorial representation depicting transformation matrices, according to certain embodiments.

FIG. 7 is an exemplary pictorial representation depicting a hyperplane dividing street parts with timestamp frames, according to certain embodiments.

FIG. 8 illustrates a flowchart of a method for constructing the 3D aerial survey of the city street scene, according to certain embodiments.

FIG. 9 is an exemplary pictorial representation depicting 3D reconstruction results for the city part, according to certain embodiments.

FIG. 10A is an exemplary pictorial representation depicting a Proof of Concept (PoC) of the stitching results, according to certain embodiments.

FIG. 10B is an exemplary pictorial representation depicting a PoC example of the stitching results, according to certain embodiments

FIG. 10C is an exemplary pictorial representation depicting another PoC example of the stitching results, according to certain embodiments.

FIG. 11A is an exemplary pictorial representation depicting a video captured from the calibrated camera setup for one timestamp, according to certain embodiments.

FIG. 11B is an exemplary pictorial representation depicting a segmentation for one time stamp, according to certain embodiments.

FIG. 11C is an exemplary pictorial representation depicting depth maps for one timestamp, according to certain embodiments.

FIG. 12A is an exemplary pictorial representation depicting a Structure from Motion (SfM) camera poses and point cloud, according to certain embodiments.

FIG. 12B is another exemplary pictorial representation depicting the SfM camera poses and point cloud, according to certain embodiments.

FIG. 12C is yet another exemplary pictorial representation depicting the SfM camera poses and point cloud, according to certain embodiments.

FIG. 13 is an illustration of a non-limiting example of details of computing hardware used in the computing system, according to certain embodiments.

FIG. 14 is an exemplary schematic diagram of a data processing system used within the computing system, according to certain embodiments.

FIG. 15 is an exemplary schematic diagram of a processor used with the computing system, according to certain embodiments.

FIG. 16 is an illustration of a non-limiting example of distributed components which may share processing with the controller, according to certain embodiments.

### DETAILED DESCRIPTION

In the drawings, reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

The present disclosure provides a system and method for constructing a three-dimensional (3D) aerial survey of a city street scene, supporting real-time processing through an optimized and quantized implementation of a 3D reconstruction technique. A calibrated multi-camera system, mounted on a moving vehicle and configured to capture a 360-degree field of view, generates video frames. The system then splits the video frames into smaller subsets or partitions. From each subset, the system identifies and removes or replaces undesired visual content, such as transient or occluding objects, thereby improving reconstruction accuracy and reducing reprojection error. The cleaned and processed frame subsets are independently reconstructed into a plurality of local 3D scene intervals. These local reconstructions are then stitched and filtered by the system to generate a unified 3D representation of the city street scene. The system enables detailed and accurate 3D modeling of urban environments, with applications in autonomous driving simulation, aerial surveying, virtual reality, and urban infrastructure planning, while effectively addressing limitations related to scene scale, dynamic content, and reconstruction fidelity.

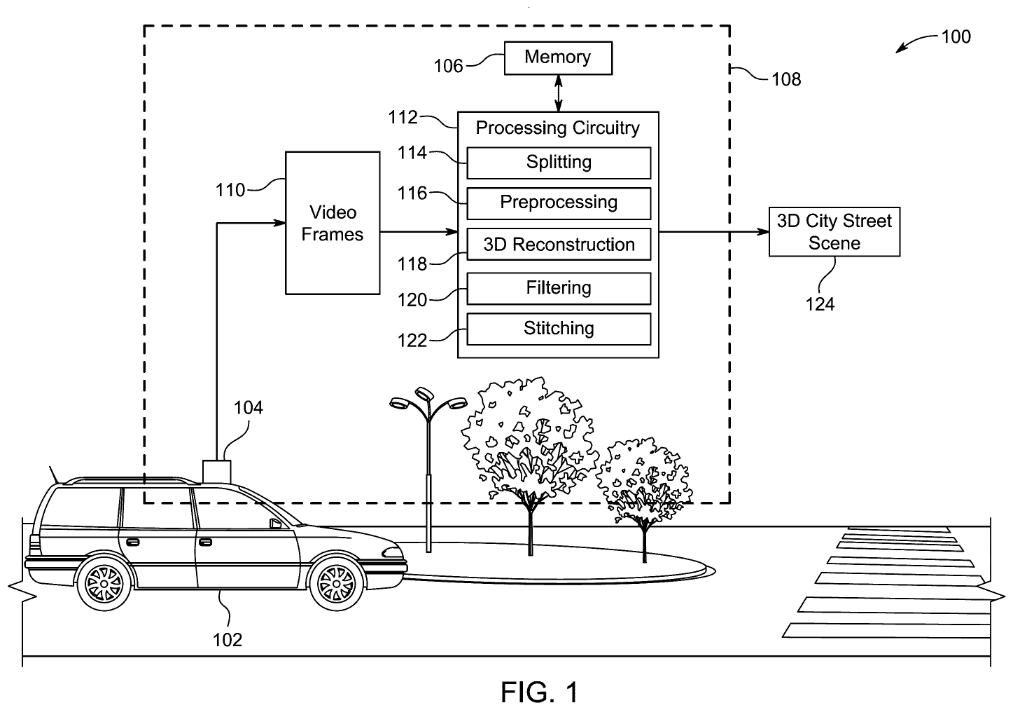

FIG. 1 shows an exemplary representation of an environment 100 comprising a system 108 for constructing a three-dimensional (3D) aerial survey of a city street scene, in accordance with an embodiment of the present disclosure. Although the environment 100 is presented in one arrangement, other arrangements may include the parts of the environment 100 (or other parts) arranged otherwise depending on, for example, splitting the video frames into a subset of video frames, preprocessing the subset to obtain a calculated information, and other operations. The environment 100 generally includes a vehicle 102 and the system 108, each coupled to, and in communication with (and/or with access to) a network system. In some embodiments, the system 108 is embodied as a cloud-based and/or SaaS-based (software as a service) architecture. In some embodiments, the system 108 may be implemented in a server system. In some embodiments, the system 108 may be implemented in a variety of edge computing devices, such as Nvidia Jetson platform, Google Coral neural processor and other low-power neural processing devices.

The Nvidia Jetson is a low-power system that is designed for accelerating machine learning applications. In particular, Nvidia Jetson comes as a computing board that can be configured with a multi-core CPU and a multi-core GPU. The computing board can include multimedia circuitry.

The network may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among two or more of the parts or users illustrated in FIG. 1, or any combination thereof.

Various entities in the environment 100 may connect to the network in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G), 6th Generation (6G) communication protocols, Long Term Evolution (LTE) communication protocols, or any combination thereof.

In an embodiment, the system 108 includes a calibrated camera setup 104, one or more communication interface device(s) or input/output (I/O) interface(s) (not shown in FIG. 1), and one or more data storage devices or a memory 106 operatively coupled to a processing circuitry 112. A calibrated camera setup is where parameters are set in a camera system and includes focal length, and position relative to a coordinate system. In the embodiment, the camera setup can enable the camera system to accurately relate the 2D image data it captures to the real-world 3D scene.

In an embodiment, the calibrated camera setup 104 is mounted on a roof of the vehicle 102. The vehicle 102 can be any type of vehicle, such as a car, a truck, a bus or a three-wheeler. In some embodiments, the calibrated camera setup 104 can be mounted on an aerial vehicle or a rail vehicle. The calibrated camera setup 104 can be a 360-degree camera or a multi-camera calibrated setup covering a 360-degree view of a city street.

The processing circuitry 112 may be a software processing module and/or a hardware processor. In an embodiment, the hardware processor can be implemented as one or more microprocessors, microcomputers, microcontrollers, digital signal processors, central processing units, state machines, logic circuitries, and/or any devices that manipulate signals based on operational instructions. Among other capabilities, the processing circuitry 112 is configured to fetch and execute computer-readable instructions stored in the memory 106.

The I/O interface(s) can include a variety of software and hardware interfaces, for example, a web interface, a graphical user interface, and the like and can facilitate multiple communications within a wide variety of networks N/W and protocol types, including wired networks, for example, LAN, cable, etc., and wireless networks, such as WLAN, cellular, or satellite. In an embodiment, the I/O interface device(s) can include one or more ports for connecting a number of devices to one another or to another server.

The memory 106 may include any computer-readable storage medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. In an embodiment, the memory 106 may store software programs and data pertaining to pre-defined formulas, training algorithms, models, and the like. The memory 106 further comprises (or may further comprise) information pertaining to input(s)/output(s) of each step performed by the systems and methods of the present disclosure. In other words, input(s) fed at each step and output(s) generated at each step are comprised in the memory 106 and can be utilized in further processing and analysis.

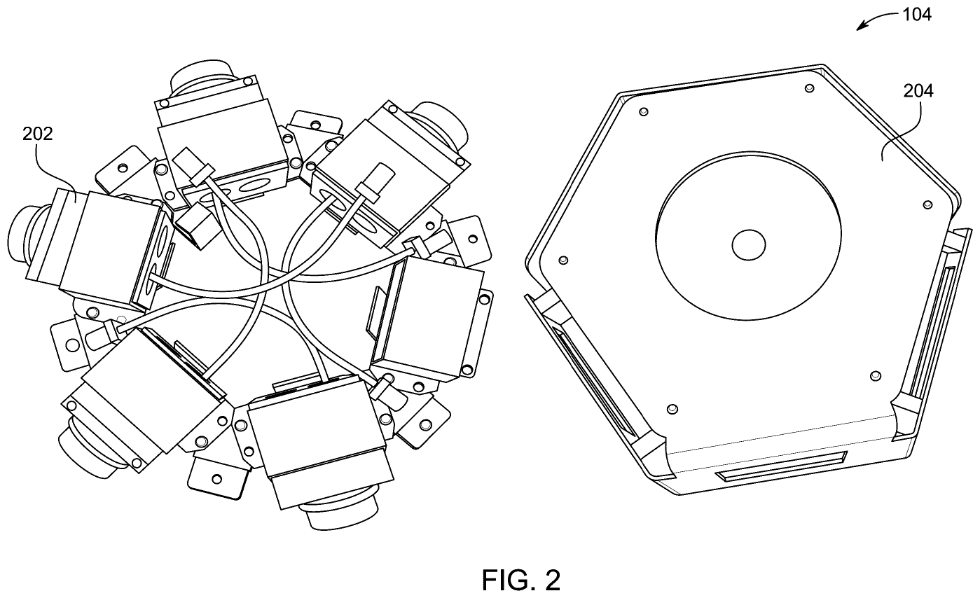

The calibrated camera setup 104 is configured to capture a sequence of video frames 110 while the vehicle 102 is operating, preferably while the vehicle is in motion. The processing circuitry 112 then obtains the sequence of video frames 110 from the calibrated camera setup 104. Thereafter, the processing circuitry 112 performs a series of processes, such as splitting 114, preprocessing 116, 3D reconstruction 118, filtering 120, and stitching 122 on the sequence of video frames 110 to provide/construct a 3D city street scene 124 (hereinafter also referred to as the 3D aerial survey). The 3D city street scene 124 is a reconstruction of the city street scene, excluding unwanted objects. In particular, the 3D city street scene 124 offers a detailed and accurate representation of city environments while overcoming limitations of a scene's size. FIG. 2 is an exemplary pictorial representation depicting the calibrated camera setup 104 for capturing the 3D aerial survey of the city street scene, in accordance with an embodiment of the present disclosure.

In an embodiment, the calibrated camera setup 104 is mounted on the roof of a vehicle, such as the vehicle 102. The calibrated camera setup 104 comprises multiple cameras arranged in a 360-degree camera arrangement 202, wherein the 360-degree camera arrangement 202 is enclosed within a camera case 204. The camera case 204 is configured to structurally support, align, and protect the multiple cameras, and to maintain a spatial calibration of the camera arrangement 202 during vehicle motion.

In some embodiments, the calibrated camera setup 104 may be variably mounted at different positions on the vehicle 102, including but not limited to, front-facing, rear-facing, or lateral (side-facing) orientations, to obtain distinct viewing perspectives.

In at least one example embodiment, the calibrated camera setup 104 may be integrated into aerial vehicles (e.g., drones) to capture top-down imagery of urban landscapes, aiding in 3D modeling and city reconstruction from an aerial viewpoint.

The cameras may include, but are not limited to, single cameras, multi-camera arrays, 360-degree omnidirectional cameras, front/rear-view cameras, dash cameras, surround view systems, or specialized optical assemblies. The cameras may be unidirectional (capturing video from a fixed direction) or multidirectional (capturing video from multiple directions simultaneously).

The calibrated camera setup 104 is configured to continuously capture video frames, providing a full 360-degree field of view during daylight conditions as the vehicle 102 moves through urban environments. The captured video frames include, but are not limited to, visual scenes containing roads, buildings, houses, under-construction areas, road humps, skywalks, railway tracks, metro lines and stations, electric poles, traffic signals, signboards, navigational indicators, street and area names, speed limit signage, and any other objects that may be along roads. The calibrated camera setup 104 is also configured to capture road characteristics, including one-way and two-way traffic lanes, narrow or wide roads, curves, turns, deviations, and diversions. The captured video frames are then shared with the processing circuitry 112, which then processes and converts them into three-dimensional (3D) city street scene, suitable for use in various applications, such as autonomous driving simulations, aerial surveying, virtual reality environments, and urban planning and infrastructure analysis.

In an exemplary embodiment, the calibrated camera setup 104 is configured to capture continuous video streams at approximately 30 frames per second. The image resolution varies depending on a camera type of the multiple cameras included in the calibrated camera setup 104, including, but not limited to, 5888×2944 pixels for 360-degree cameras and 1080×1920 pixels for Real-Time Streaming Protocol (RTSP) cameras.

In at least one example embodiment, the calibrated camera setup 104 captures the video streams in perspective view or equirectangular format, which are then utilized to generate a large-scale, ground-level digital twin of an urban area/locality from their ground street view. In this disclosure, a digital twin is a virtual representation, i.e., digital counterpart, of the actual urban area/locality.

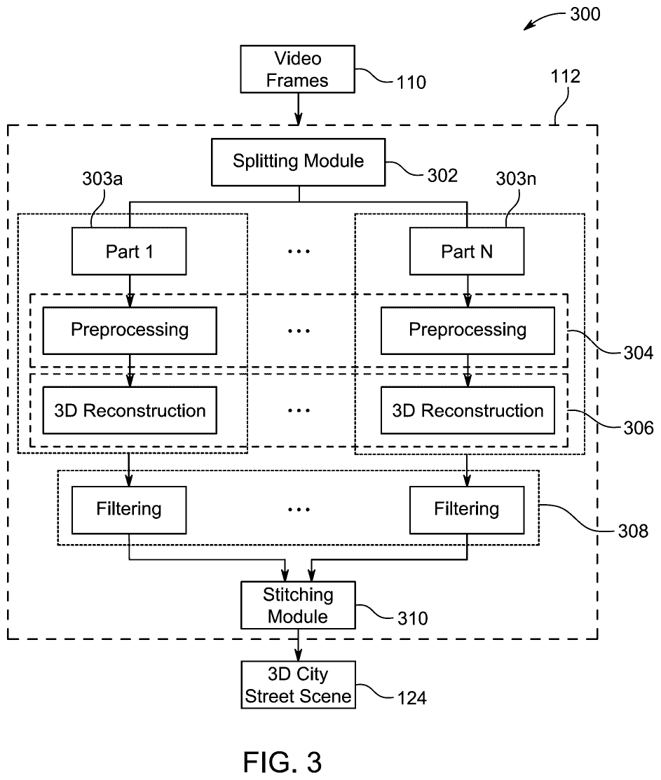

FIG. 3 illustrates a schematic block diagram representation 300 of a 3D aerial survey construction process followed by the system 108 of FIG. 1 for constructing the 3D aerial survey of the city street scene, according to certain embodiments.

In one embodiment, the block diagram representation 300 includes the processing circuitry 112 that further includes a splitting module 302, a preprocessing module 304, a 3D reconstruction module 306, a filtering module 308 and a stitching module 310. As discussed earlier, the calibrated multi-camera setup 104 covering the 360-degree view mounted on the moving vehicle 102 is configured to capture the sequence of video frames 110 (also referred to as the video frames 110) while the vehicle 102 is traveling. The video frames 110 are then sent to the processing circuitry 112.

The processing circuitry 112, upon receiving the sequence of video frames 110, performs the 3D aerial survey construction process based on the received video frames 302 for constructing the 3D aerial survey of the city street scene. In particular, the splitting module 302 of the processing circuitry 112 receives the video frames 110 and splits the received video frames 110 into 3D parts 303a-303n. Each part of the 3D parts 303a-303n contains a subset of the sequence of video frames 110. In particular, all the perceptual information contained in the video frames 110 is divided into the 3D parts 303a-303n, with each part containing the substantially the same number of video frames. Furthermore, the splitting module 302 follows a partitioning strategy that splits the video frames into distinct regions while preserving a temporal intersection at a shared timestamp between adjacent regions. In particular, as part of the partitioning strategy, each adjacent part of the 3D parts is configured to include a shared set of frames corresponding to a common timestamp, such that a set of overlapping feature points is present between neighboring partitions. The inclusion of the shared timestamp facilitates continuity and alignment across part boundaries, thereby supporting downstream processing such as feature matching, stitching, or 3D reconstruction.

In other words, adjacent regions contain one shared timestamp for visual data, including several images with different camera positions that can be matched using a calculated transformation matrix. All street sectors are forwarded to the 3D reconstruction pipeline for processing in parallel. The pipeline consists of foundation model processing and Gaussian Splatting training. After getting a set of 3D reconstructed scenes, all neighboring regions are merged using transformation matrices calculated by shared camera poses. Furthermore, the system includes a filtering module that exploits the calculated hyperplane between adjacent cameras to prune intersecting ellipsoids.

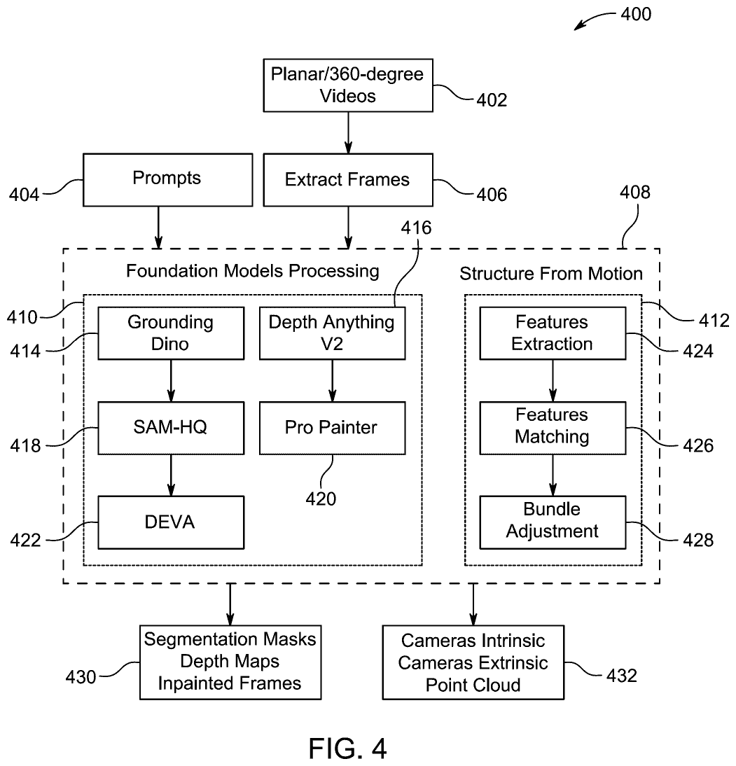

Subsequently, each part of the 3D parts 303a-303n is preprocessed in parallel by the preprocessing module 304. In an embodiment, the preprocessing module 304 preprocesses the subset of the sequence of video frames of each part of the 3D parts 303a-303n to obtain calculated information for the respective part. In particular, as part of the preprocessing, objects that are to be excluded from each part are removed, and the calculated information is obtained. A preprocessing process performed by the preprocessing module 304 for providing the calculated information for each part is explained in greater detail with reference to FIG. 4.

Once the calculated information is available for each part, the 3D reconstruction module 306 is configured to construct, in parallel, a 3D representation of each part based on the calculated information to obtain local 3D reconstructed scene intervals. The 3D reconstruction module 306 is also configured to refine the local 3D reconstructed scene intervals based on a bundle adjustment technique to minimize reprojection errors present in each local 3D reconstructed scene interval. In an embodiment, the bundle adjustment technique is a non-linear least-squares optimization.

Further, the filtering module 308 receives the local 3D reconstructed scene intervals corresponding to the 3D parts. The filtering module 308 is configured to, in parallel, convert a local coordinate of each local 3D reconstructed scene interval of the local 3D reconstructed scene intervals represented by an ellipsoid based on a Kabsch-Umeyama algorithm to obtain a structure-from-motion (SfM) coordinate. The Kabsch-Umeyama algorithm is described further below. Then, the filtering module 308 is configured to calculate a hyperplane between two adjacent local 3D reconstructed scene intervals of the local 3D reconstructed scene intervals. Thereafter, the filtering module 308 is configured to filter out noise based on the hyperplane to obtain, in parallel, the filtered local 3D reconstructed scene intervals, which are then fed to the stitching module 310.

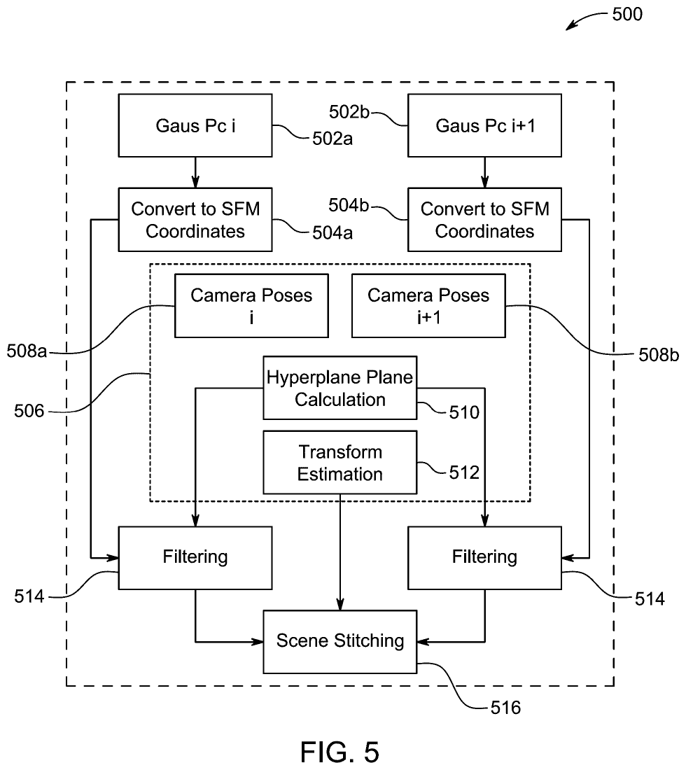

The stitching module 310 is configured for merging the filtered local 3D reconstructed scene intervals and stitching them to construct the 3D city street scene 124. The processes of filtering and stitching are explained in detail with reference to FIG. 5.

FIG. 4 illustrates a schematic block diagram representation of a preprocessing process followed by the system of FIG. 1 for preprocessing videos, according to certain embodiments.

As shown in FIG. 4, the processing circuitry 112, upon receiving the 360-degree videos captured by the calibrated camera setup 104, is configured to sample the received videos at predefined intervals (e.g., based on time, motion, or scene content) to extract individual frames 406 for further processing. Each extracted individual frame preserves the full 360-degree field of view and retains metadata such as timestamp, camera pose, date, location, depending on camera configuration.

The individual frames 406, along with one or more prompts 404, each prompt including one or more object identifiers corresponding to particular objects designated for exclusion, are then provided to the preprocessing module 304, comprising a foundation model processing component 410. In an embodiment, the foundation model processing component 410 is configured with a set of pretrained neural network models, such as a prompt-based video segmentation module, an object detection model, and a tracking foundation model. Examples of the pretrained neural network models may include, but are not limited to, a Grounding DINO 414 for object detection and grounding based on the provided prompts, a Depth Anything V2 416 for generating dense depth estimations, a Segment Anything in High Quality model (SAM-HQ) 418 for high-resolution semantic segmentation, a Pro Painter 420 for inpainting regions corresponding to excluded objects and DEVA 422 for extracting spatiotemporal visual features.

In one embodiment, the Grounding transformer-based object detector Improved DeNoising Optimization (DINO) 414 enables language-guided object detection across multiple camera views, enhancing 3D parts by ensuring consistent semantic object matching and accurate triangulation. In particular, the Grounding DINO 414 performs object detection and grounding based on textual prompts 404, thereby enabling semantic localization of objects within the video frames. The Grounding DINO 414 interprets natural language, detects and localizes relevant objects that are to be excluded within each video frame, thereby effectively bridging human intent with visual data.

In one embodiment, the Depth Anything V2 416 generates and fuses monocular depth maps into a unified 3D model, offering high accuracy and efficiency. The Depth Anything V2 416 is configured to estimate dense depth maps from monocular Red, Green, Blue (RGB) images present in video frames, facilitating geometric understanding of the city street scene. The Depth Anything V2 416 estimates a dense depth map from each video frame, providing a detailed understanding of the city street scene geometry. In particular, the Depth Anything V2 416 enhances the visual completeness of the city street scene, especially in the case of occluded or missing regions.

In one embodiment, the SAM-HQ 418 is an enhanced segmentation model that improves mask accuracy via high-quality output tokens and global-local feature fusion. The SAM-HQ 418 produces sharper and more accurate object masks on image frames to enhance the original image. In particular, the SAM-HQ 418 enables precise object boundary extraction from 2D image frames, enhancing depth estimation and surface modelling. Once objects are identified by Grounding DINO 414, the SAM-HQ 418 generates precise segmentation masks, isolating each object or region of interest with high fidelity.

In one embodiment, the Pro Painter 420 is a video inpainting framework that restores missing or occluded regions in image sequences using dual-domain propagation and sparse attention. In 3D parts, the Pro Painter 420 enhances texture continuity and surface completeness across views and time.

In one embodiment, the Dynamic Epipolar View Aggregation (DEVA) 422 enhances the 3D reconstruction system 108 by aggregating epipolar-consistent views from multiple cameras. In particular, it improves depth estimation accuracy by leveraging spatial and temporal coherence across the cameras. The DEVA 422 is also configured to integrate multi-view or temporal data for consistent 3D scene and viewpoint-aware rendering.

The foundation model processing component 410 then uses the set of pretrained neural network models to provide segmentation masks, depth maps, and inpainted frames 430 with undesired objects removed or replaced, thereby producing refined video data suitable for subsequent 3D reconstruction and scene modeling tasks.

In an embodiment, the preprocessing module 304 is further configured with a structure-from-motion (SfM) component 412 configured to perform feature extraction 424, feature matching 426, and bundle adjustment 428 on the extracted frames to generate intrinsic camera parameters, extrinsic camera poses, and a corresponding 3D point cloud 432. The structure-from-motion technique involves feature extraction, where distinctive features, such as corners or edges, are extracted from each image. These features are then matched between images to establish correspondences. The relative camera poses between images are estimated using the matched features, which involves solving a Perspective-n-Point (PnP) problem to find the camera pose that best explains the observed feature correspondences. The 3D points corresponding to the matched features are then triangulated using the estimated camera poses. Finally, the entire reconstruction is refined through a non-linear least-squares optimization, known as bundle adjustment, to minimize the reprojection error.

It has been determined that the SfM component 412 configured to process equirectangular image frames, presents challenges due to their non-perspective projection characteristics. To address these challenges, the SfM component 412 uses cylindrical or spherical projection models that compensate for geometric distortions inherent in equirectangular images and facilitate more accurate estimation of camera poses and 3D structure. In an embodiment, the SfM component 412 uses omnidirectional feature descriptors, specifically designed to accommodate repetitive patterns and angular continuity associated with 360-degree views, to further enhance the camera poses and 3D structure.

In at least one example embodiment, the SfM component 412 is configured to perform: (i) feature extraction using one or more algorithms designed for omnidirectional projections, (ii) feature matching taking into account cylindrical projection and feature repetition, (iii) camera pose estimation based on matched features and the cylindrical projection, (iv) 3D point reconstruction using the estimated poses and the cylindrical projection, and (v) bundle adjustment to jointly refine the 3D reconstruction, thereby minimizing overall reprojection error.

FIG. 5 illustrates a schematic block diagram representation 500 of the filtering process and the stitching process followed by the system of FIG. 1 for constructing the 3D aerial survey of the city street scene, according to certain embodiments.

As discussed earlier, the processing circuitry 112, upon receiving the sequence of video frames 110, splits the sequence of video frames 110 into the 3D parts, each containing a subset of the video frames. Further, to enable global alignment across the parts/segments, the processing circuitry 112 uses the partitioning strategy in which adjacent parts share at least one timestamp intersection to ensure a set of common 3D feature points between neighboring parts. In an embodiment, in the case of a multi-camera setup, the number of shared points is equal to the number of cameras active at the overlapping timestamp. In an equirectangular case, there is only one picture for one timestamp, but several planar images can be defined. An example implementation exploits at least four shared camera origins to calculate the transformation matrix from one scene to another using the Kabsch-Umeyama algorithm. Further, the processing circuitry 112 constructs, in parallel, the 3D representation of each part of the parts based on the calculated information to obtain the local 3D reconstructed scene intervals.

In an embodiment, once the local 3D reconstructed scene intervals are provided to the filtering module 308, the filtering module 308a converts, in parallel, a local coordinate of each local 3D reconstructed scene interval of the local 3D reconstructed scene intervals represented by an ellipsoid based on a Kabsch-Umeyama algorithm to obtain a structure-from-motion (SfM) coordinate. In particular, the Kabsch-Umeyama algorithm is a method for aligning two-point sets to compute optimal rotation, translation, and optional scaling, minimizing alignment error for applications in spatial registration and 3D data processing. The approach calculates the rotation matrix, translation vector, and scale between two scenes.

P and Q represent two sets of ellipsoid midpoints that can be matched. The shift between P and Q is estimated using their normalized centroids. After that, the rotation matrix is estimated using the cross-covariance matrix H between the two matched sets of 3D coordinates.

First, the covariance matrix (SVD) is calculated for the covariance matrix H.

$$H = U Σ {V}^{T} \qquad ( 1 )$$

Where: U and V=orthogonal and Σ=diagonal.

Next, record if the orthogonal matrices contain a reflection,

$$d = sign ( det ( {UV}^{T} ) ) = det ( U ) det ( V ) \qquad ( 2 )$$

Finally, the optimal rotation matrix R is calculated as

$$R = U ( \begin{matrix}1 & 0 & 0 \\ 0 & 1 & 0 \\ 0 & 0 & d\end{matrix} ) {V}^{T} \qquad ( 3 )$$

The R minimizes

$${\sum }_{k = 1}^{N} \vert {Rq}_{k} - {p}_{k} \vert ,$$

where: qₖ anu pₖ are rows in Q and P respectively.

As seen in FIG. 5, the filtering module 308 converts a local coordinate of each of two adjacent local 3D reconstructed scene intervals Gaus PC i 502a and Gaus PC i+1 502a, using the Kabsch-Umeyama algorithm, to provide an SfM coordinate 504a and an SfM coordinate 504b, respectively.

In an embodiment, each 3D reconstructed scene interval is represented by ellipsoids characterized by position, anisotropic covariance, opacity, and spherical harmonic coefficients for view dependent colors.

$$\begin{matrix}{GS}_{i} = ( {G}_{1} ( x ) , {G}_{2} ( x ) , … , {G}_{N} ( x ) ) \\ G ( x ) = {e}^{- \frac{1}{2} {( x - μ )}^{T} {Σ}^{- 1} ( x - μ )} , Σ = {RSS}^{T} {R}^{T}\end{matrix} \qquad ( 4 )$$

One scene can be transformed into another coordinate system using scale, rotation and translation. Let S, R and T be the values respectively, then Gaussian transformation can be represented as:

$${G}_{μ} = {R}^{T} \cdot ( {G}_{μ} / s - t ) , {G}_{s} = {G}_{s} + log ( s ) , {G}_{R} = {R}^{T} \cdot {G}_{R} \qquad ( 5 )$$

In an embodiment, the colors of final renderings can be broken without spherical harmonics rotation. So, to tackle it, a Wigner D-matrix is used. Consider a rotation R about the origin that sends the unit vector r to r′. Under this operation, a spherical harmonic of degree I and order m transforms into a linear combination of spherical harmonics of the same degree. That is

$${Y}_{ℓ}^{m} ( {r}^{′} ) = {\sum }_{{m}^{′} = - ℓ}^{ℓ} {A}_{{mm}^{′}} {Y}_{ℓ}^{{m}^{′}} ( r ) \qquad ( 6 )$$

Further, the filtering module 308, performing a filtering process 506, calculates a hyperplane (at 510) between two adjacent local 3D reconstructed scene intervals, Gaus PC i 502a and Gaus PC i+1 502a, of the plurality of local 3D reconstructed scene intervals. In particular, a hyperplane is calculated between neighboring regions using adjacent camera poses (e.g., poses 508a-508b) from different scenes. Let (Pₖ_{_{i−1}}₊₁, P₂, . . . , Pₖ_{ᵢ}) and (Pₖ_{ᵢ}₊₁, P₂, . . . , Pₖ_{ᵢ}) camera poses for i-th region, then the hyperplane is defined by a normal and bias:

$${n}_{i} = {P}_{{k}_{i} + 1} - {P}_{{k}_{i}} , {b}_{i} = 〈 {n}_{i} , ( {P}_{{k}_{i}} + {P}_{{k}_{i} + 1} ) / 2 〉 \qquad ( 7 )$$

Sᵢ= [symbol] nᵢ, p [symbol] +bᵢ-dividing the hyperplane between i-th and i+1-th regions

In an embodiment, the filtering module 308 uses a transformation estimation technique (at step 512) to compute the relative transformations between overlapping point cloud segments. The transformation estimation technique brings everything into a unified 3D space.

In an embodiment, the filtering module 308 uses a filtering mechanism (at step 514) based on the sign of the calculated scalar product between the hyperplane and the mean of the Gaussian distributions. In particular, the filtering module 308 filters noise in each 3D reconstructed scene interval based on its respective hyperplane to obtain a filtered local 3D reconstructed scene interval corresponding to the 3D reconstructed scene interval. The filtering module 308 provides, in parallel, filtered local 3D reconstructed scene intervals corresponding to the 3D reconstructed scene intervals. This step enables the system 108 to selectively retain or discard Gaussian components based on their orientation on a respective side of the hyperplane.

Subsequently, all scenes in global coordinates are merged, thereby facilitating a unified representation of the data.

$$\hat{{GS}_{l}} = \{ 1 [ 〈 {S}_{i} , {G}_{j} ( x ) 〉 > 0 ] , j ∈ 1 … K \} \qquad ( 8 )$$

Where, G\hat{ }S_{ι}=filtered Gaussian splatting scene.

Finally, the stitching module 310 performs scene stitching (at step 516) to stitch the filtered local 3D reconstructed scene intervals to construct the 3D city street scene. The stitching module 310 integrates all processed point clouds into a unified 3D model. The stitching module 310 resolves overlaps, fills gaps, and ensures continuity across segments.

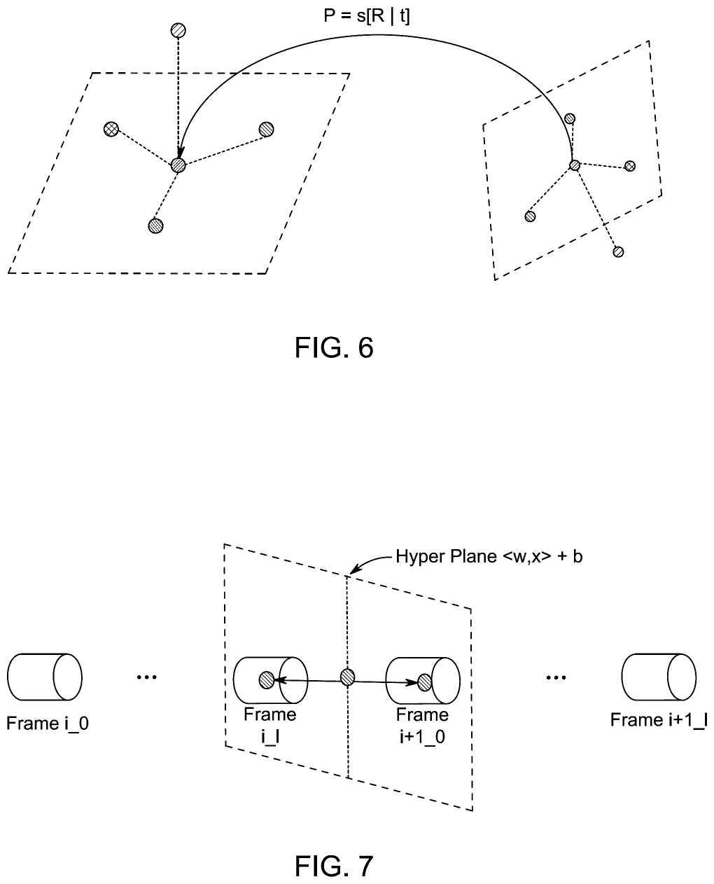

FIG. 6 is an exemplary pictorial representation depicting transformation matrices, according to certain embodiments. The Kabsch-Umeyama algorithm is used to estimate the optimal similarity transformation between two adjacent frames i and i+1. One camera poses for last frame i-th part, and another camera poses for first frame in i+1-th part. The transformation matrices are estimated using one timestamp camera intersections between street subregions. The Kabsch-Umeyama algorithm involves calculation of the optimal rotation matrix that minimizes the RMSD (root mean squared deviation) between two paired sets of points.

FIG. 7 is an exemplary pictorial representation depicting a hyperplane dividing street parts with timestamp frames, according to certain embodiments. As seen in FIG. 7, a street environment is divided into distinct spatial regions using a dynamically computed hyperplane, which separates different parts of the city street scene (e.g., pedestrian zones, vehicle lanes, or delivery areas). In particular, the system 108 partitions a continuous urban environment into discrete spatial segments by computing a hyperplane that adaptively separate street parts based on geometric and temporal coherence.

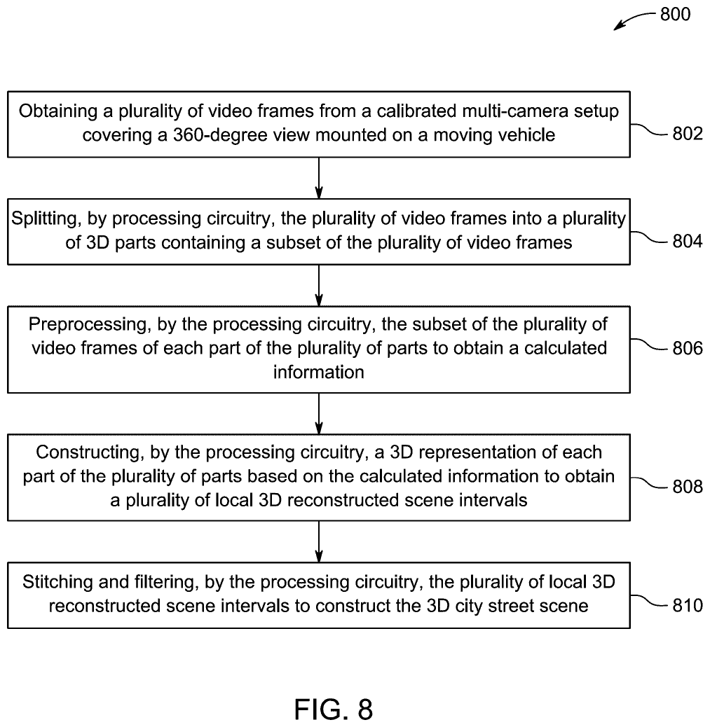

FIG. 8 illustrates a flow chart of a method 800 for constructing a three-dimensional (3D) aerial survey of the city street scene, according to certain embodiments. In an embodiment, the system 108 comprises one or more data storage devices or the memory 106 operatively coupled to the processing circuitry 112 and is configured to store instructions for execution of steps of the method 800 by the processing circuitry 112. The sequence of steps of the flow chart may not be necessarily executed in the same order as they are presented. Further, one or more steps may be grouped together and performed in form of a single step, or one step may have several sub-steps that may be performed in parallel or in a sequential manner. The steps of the method of the present disclosure will now be explained with reference to the components of the system 108 as depicted in FIG. 1.

At step 802, the method 800 includes obtaining the sequence of video frames 110 from a calibrated multi-camera setup 104 covering a 360-degree view mounted on a traveling vehicle 102.

At step 804, the method 800 includes splitting, by the processing circuitry 112, the sequence of video frames 110 into the 3D parts containing a subset of the sequence of video frames 110. In an embodiment, splitting 114 includes dividing the sequence of video frames 110 into one timestamp to create parts of equal size. Further, models are trained in a parallel processing pipeline based on Gaussian Splitting (GS) and NeRF with normalized camera poses and a point cloud from the SfM 412, supervised by segmentation masks and depth maps.

At step 806, the method 800 includes the preprocessing 116, by the processing circuitry 112, the subset of the sequence of video frames 110 of each part of the parts to obtain a calculated information. In an embodiment, the preprocessing 116 includes identifying objects to be excluded based on a scene reconstruction framework having the prompt-based video segmentation module, the object detection model, and the tracking foundation model from the subset of the sequence of video frames 110 of each part of the parts. The preprocessing 116 includes removing the objects to be excluded and reconstructing the sequence of video frames 110 based on a video inpainting model.

In an embodiment, the preprocessing 116 further includes estimating, by the processing circuitry 112, camera poses and a point cloud based on an SfM approach, which consists of distinctive features, including corners or edges, extracted from each image, training a view synthesis model with the camera poses and the point cloud, and obtaining the calculated information based on the view synthesis model.

At step 808, the method 800 includes constructing, by the processing circuitry 112, a 3D representation of each part of the parts based on the calculated information to obtain local 3D reconstructed 126 scene intervals. In an embodiment, the constructing includes refining the local 3D reconstructed scene intervals based on a bundle adjustment technique, which is a non-linear least-squares optimization.

At step 810, the method 800 includes the filtering and the stitching, by the processing circuitry 112, the local 3D reconstructed scene intervals to construct the 3D city street scene 124. In an embodiment, the filtering includes converting a local coordinate of each local 3D reconstructed scene interval of the local 3D reconstructed scene intervals represented by an ellipsoid based on a Kabsch-Umeyama algorithm to obtain a SfM coordinate and calculating a hyperplane between two adjacent local 3D reconstructed scene intervals of the local 3D reconstructed scene intervals.

In the embodiment, the filtering further includes filtering a noise based on the hyperplane to obtain filtered local 3D reconstructed scene intervals. In an embodiment, the stitching 130 includes stitching the filtered local 3D reconstructed scene intervals to construct the 3D city street scene 124.

In an embodiment, the stitching 130 includes merging and aligning local Gaussian point cloud scenes, building a large-scale digital twin of the 3D city street scene 140, and leveraging transforms calculated via intersections of the camera poses over a shared timestamp for neighboring the 3D parts.

In the embodiment, the constructed 3D city street scene 124 is imported into a virtual reality application.

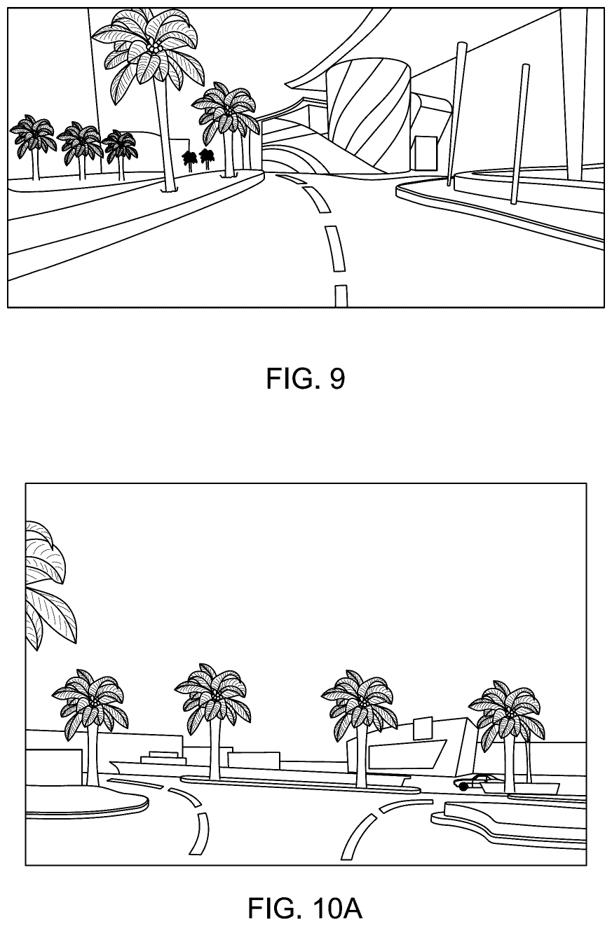

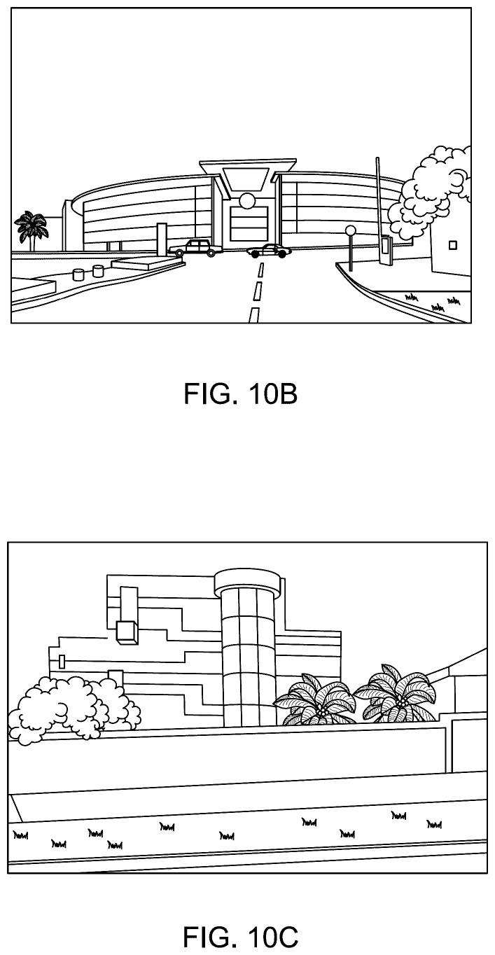

FIGS. 9 and 10A-10C are exemplary pictorial representations depicting a 3D reconstruction result for different city street scenes, according to certain embodiments.

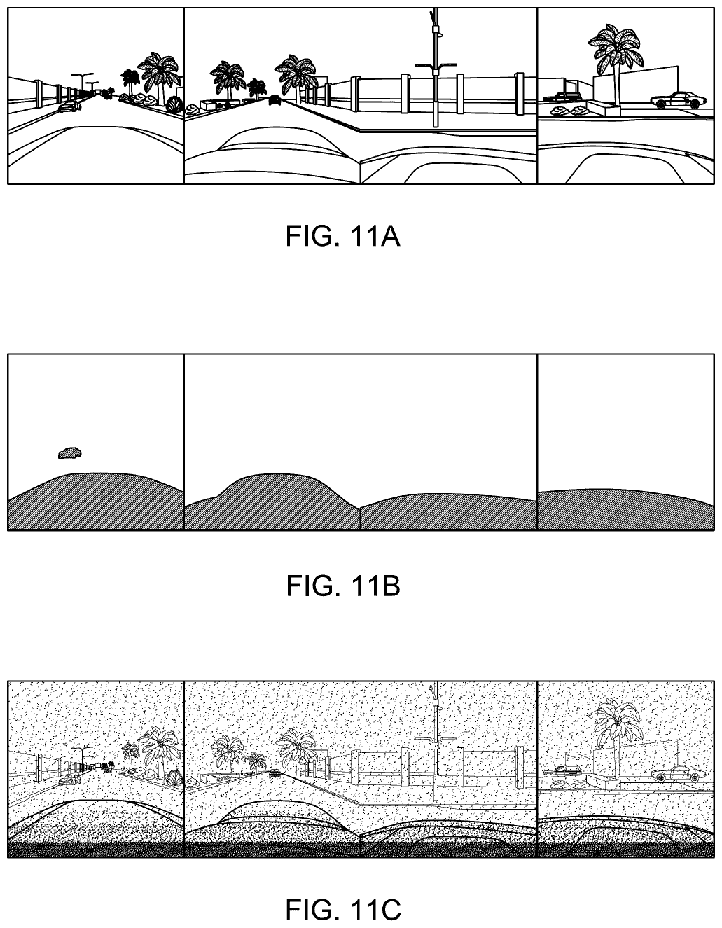

FIGS. 11A-11C are exemplary pictorial representations depicting a 3D aerial survey of different city street scenes, according to certain embodiments.

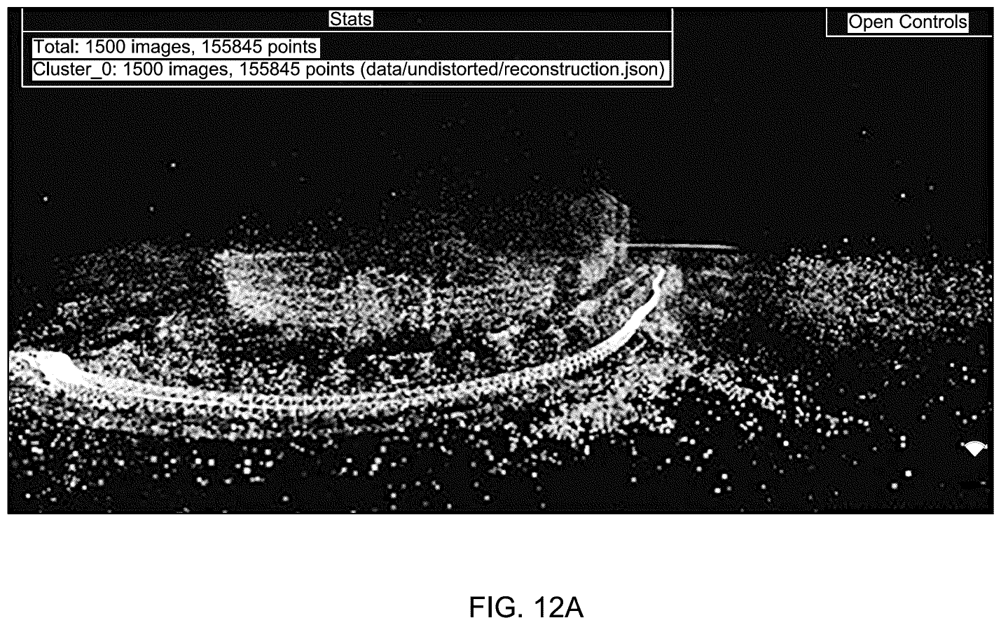

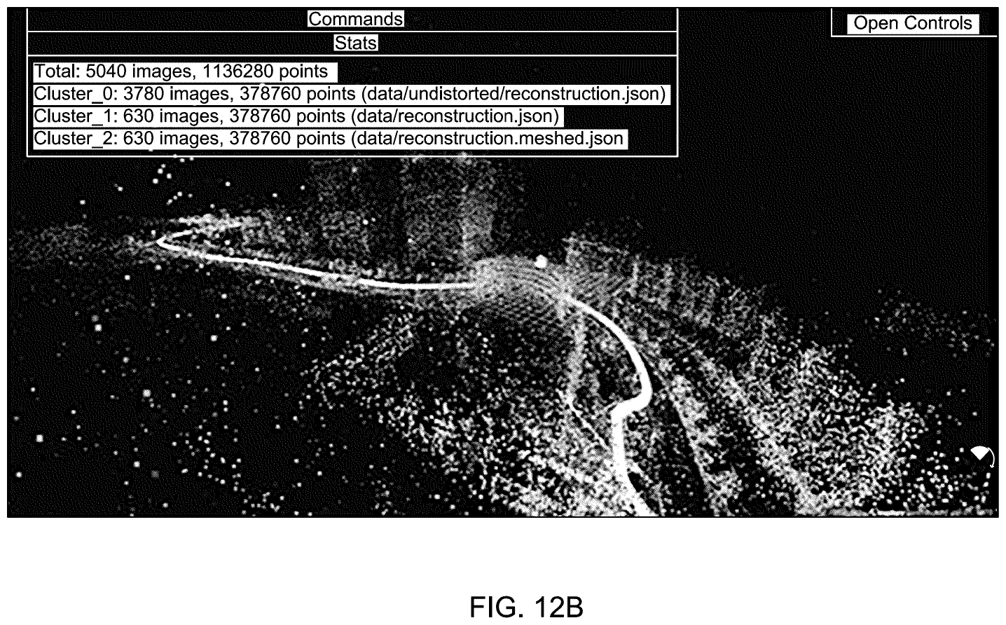

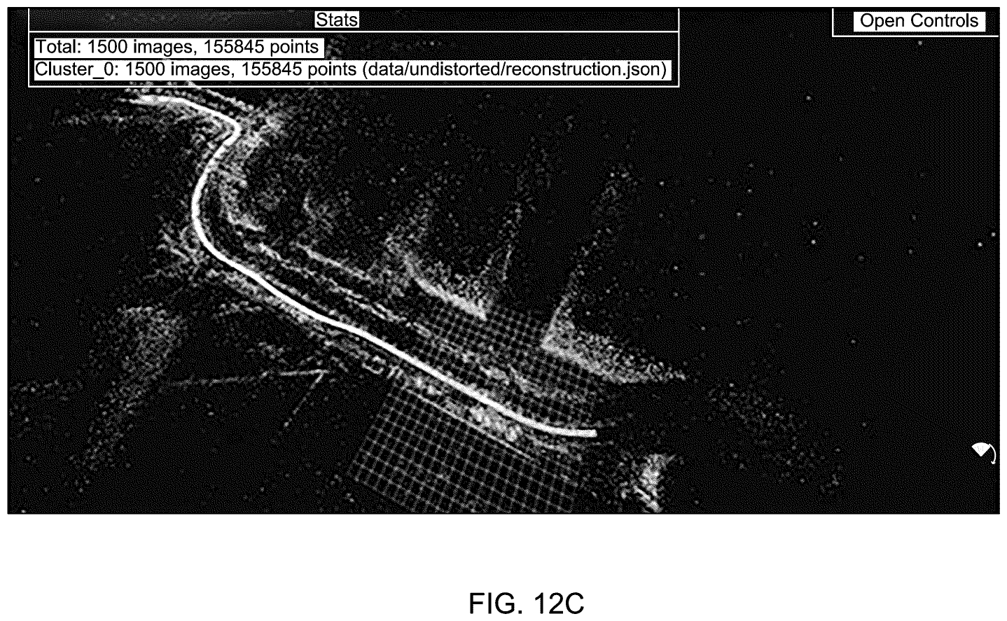

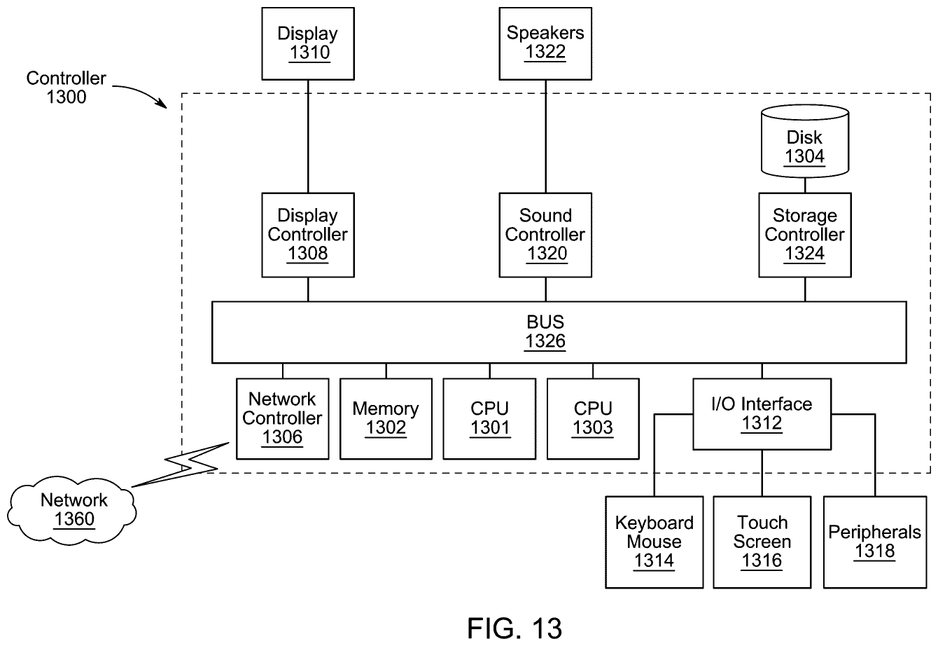

FIGS. 12A-12C are exemplary pictorial representations depicting SfM camera poses and point cloud. In particular, the pictorial representations present an exemplary output of a SfM process, comprising a plurality of camera poses and a corresponding sparse point cloud representation of a 3D city street scene.

An aspect is city street scenes 3D reconstruction that excludes dynamic objects such as cars, people, and other moving objects, from video captures obtained using a 360-degree camera or multi-camera calibrated setup mounted on a moving vehicle. The 3D reconstruction involves processing stages such as partitioning, foundation models-based video preprocessing, structure-from-motion, 3D reconstruction, subregion stitching and filtering.

An aspect is a computer-implemented pipeline for creating a digital twin that includes the following stages: capturing videos from a specified source; defining prompt-based video segmentation masks and inpainted videos to exclude specific objects from the final scene; estimating camera poses and a point cloud using a structure-from-motion approach; training view synthesis models with depth and normal supervision for different small city parts; and merging the results with post-processing techniques.

An aspect is an approach that leverages predefined text prompts and video foundation models to detect, segment, track, and inpaint objects influencing fundamental city infrastructure. The extracted information is utilized during the ray sampling stage in the training Novel View Synthesis, thereby circumventing the reconstruction of spaces with unwanted objects.

An aspect is a framework that exploits the COLMAP and OpenSFM libraries to iteratively detect landmarks, match them, and perform a bundle adjustment procedure, ultimately estimating the global camera positions and reconstructing a 3D point cloud from frames. The framework is capable of handling perspective as well as equirectangular images.

An aspect is a method that includes dividing a scene into overlapping in one timestamp equal-sized parts, followed by a parallel processing pipeline, including training models based on GS and NeRF with normalized local camera poses and a point cloud from SfM, supervised by segmentation masks and depth maps.

An aspect is an implementation of a stitching module for merging, aligning local Gaussian point cloud scenes, and building a large-scale level digital twin of the city, leveraging transforms that are calculated via camera poses intersections over a shared timestamp for neighboring street parts.

An aspect is a filtering strategy of intersected ellipsoids between adjacent sectors using a dividing hyperplane estimated from the previous region's final camera position and the next one initial camera position to reduce noise, collisions and border artifacts.

An aspect is a method for utilizing 3D reconstructed models in various fields, including generation of detailed 3D models of city streets and applying these models in autonomous driving simulations, aerial surveying, virtual reality applications, and urban planning.

An aspect is a method that has been applied to urban areas in cities. The method is characterized by simplicity, fast processing speed, parallelizable manner of stitching. The postprocessing module with 3D reconstructed approaches indicate the system's practicality, scalability, and efficiency.

Next, further details of the hardware description of the computing environment according to exemplary embodiments are described with reference to FIG. 13. In FIG. 13, a controller 1300 is described as representative of the system in which the controller is a computing device which includes a CPU 1301 which can perform the processes described above/below. The process data and instructions may be stored in memory 1302. These processes and instructions may also be stored on a storage medium disk 1304 such as a hard drive (HDD) or portable storage medium or may be stored remotely.

Further, the present disclosure is not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the present disclosure may be provided as a utility application, background daemon, or component of an operating system, or combination thereof, executing in conjunction with CPU 1301, 1303 and an operating system such as Microsoft Windows 13, Microsoft Windows 10, UNIX, LINUX, Apple MAC-OS and other systems known to those skilled in the art.

The hardware elements to achieve the computing device may be realized by various circuitry elements, known to those skilled in the art. For example, CPU 1301 or CPU 1303 may be a Xenon or Core processor from Intel of America or an Opteron processor from AMD of America, or maybe other processor types that would be recognized by one of ordinary skill in the art. Alternatively, the CPU 1301, 1303 may be implemented on an FPGA, ASIC, PLD or using discrete logic circuits, as one of the ordinary skills in the art would recognize. Further, CPU 1301, 1303 may be implemented as multiple processors cooperatively working in parallel to perform the instructions of the inventive processes described above.

The computing device in FIG. 13 also includes a network controller 1306, such as an Intel Ethernet PRO network interface card from Intel Corporation of America, for interfacing with network 1360. As can be appreciated, the network 1360 can be a public network, such as the Internet, or a private network such as an LAN or WAN network, or any combination thereof and can also include PSTN or ISDN sub-networks. The network 1360 can also be wired, such as an Ethernet network, or can be wireless such as a cellular network including EDGE, 3G, 4G, and 5G wireless cellular systems. The wireless network can also be Wi-Fi, Bluetooth, or any other wireless form of communication that is known.

The computing device further includes a display controller 1308, such as a NVIDIA GeForce GTX or Quadro graphics adaptor from NVIDIA Corporation of America for interfacing with display 1310, such as a Hewlett Packard HPL2445w LCD monitor. A general purpose I/O interface 1312 interfaces with a keyboard and/or mouse 1314 as well as a touch screen panel 1316 on or separate from display 1310. General purpose I/O interface also connects to a variety of peripherals 1318 including printers and scanners, such as an OfficeJet or DeskJet from Hewlett Packard.

A sound controller 1320 is also provided in the computing device such as Sound Blaster X-Fi Titanium from Creative, to interface with speakers/microphone 1322 thereby providing sounds and/or music.

The general-purpose storage controller 1324 connects the storage medium disk 1304 with communication bus 1326, which may be an ISA, EISA, VESA, PCI, or similar, for interconnecting all the components of the computing device. A description of the general features and functionality of the display 1310, keyboard and/or mouse 1314, as well as the display controller 1308, storage controller 1324, network controller 1306, sound controller 1320, and general purpose I/O interface 1312 is omitted herein for brevity as these features are known.

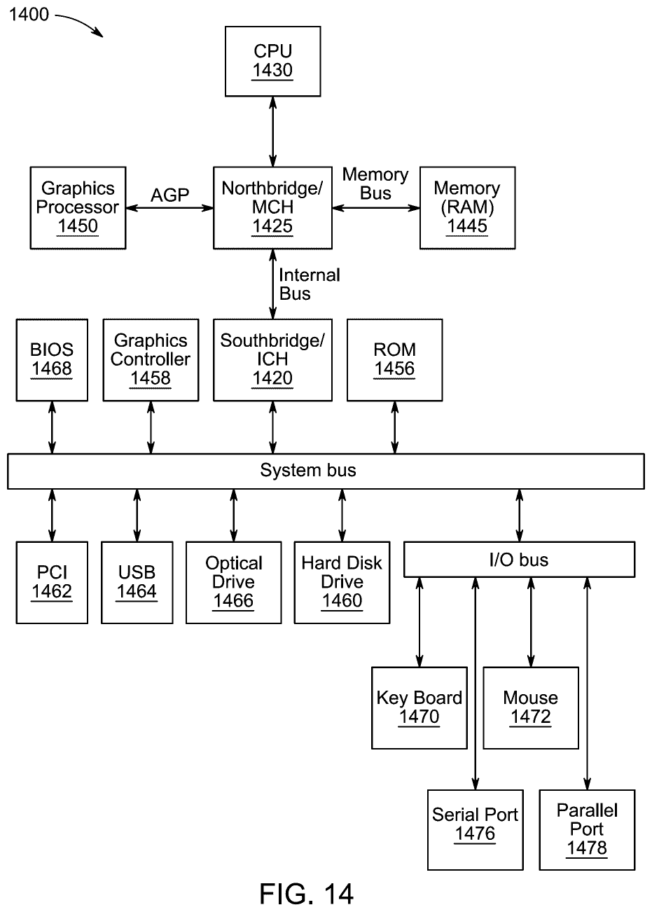

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 14.

FIG. 14 shows a schematic diagram of a data processing system, according to certain embodiments, for performing the functions of the exemplary embodiments. The data processing system is an example of a computer in which code or instructions implementing the processes of the illustrative embodiments may be located.

In FIG. 14, data processing system 1400 employs a hub architecture including a north bridge and memory controller hub (NB/MCH) 1425 and a south bridge and input/output (I/O) controller hub (SB/ICH) 1420. The central processing unit (CPU) 1430 is connected to NB/MCH 1425. The NB/MCH 1425 also connects to the memory 1445 via a memory bus and connects to the graphics processor 1450 via an accelerated graphics port (AGP). The NB/MCH 1425 also connects to the SB/ICH 1420 via an internal bus (e.g., a unified media interface or a direct media interface). The CPU Processing unit 1430 may contain one or more processors and even may be implemented using one or more heterogeneous processor systems.

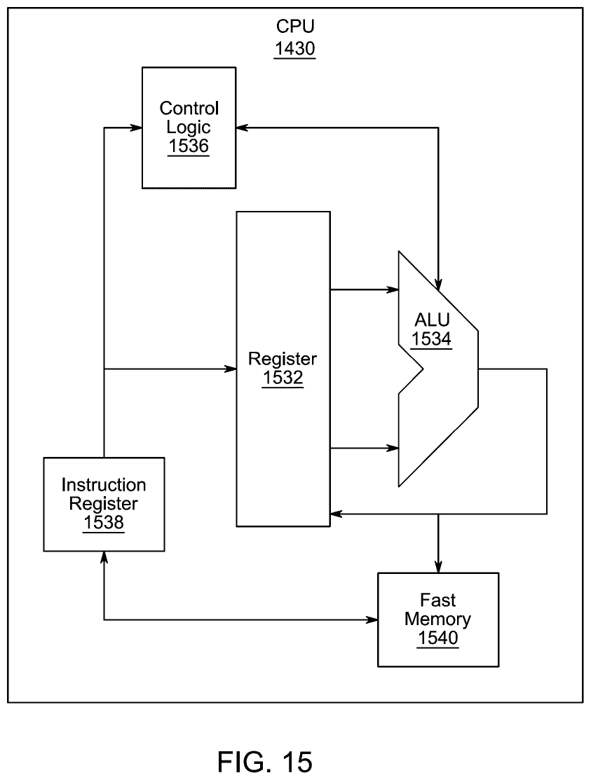

For example, FIG. 15 shows one implementation of CPU 1430. In one implementation, the instruction registers 1538 retrieves instructions from the fast memory 1540. At least part of these instructions is fetched from the instruction register 1538 by the control logic 1536 and interpreted according to the instruction set architecture of the CPU 1430. Part of the instructions can also be directed at the register 1532. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 1534 that loads values from the register 1532 and performs logical and mathematical operations on the loaded values according to the instructions. The results from these operations can be feedback into the register and/or stored in the fast memory 1540. According to certain implementations, the instruction set architecture of the CPU 1430 can use a reduced instruction set architecture, a complex instruction set architecture, a vector processor architecture, and a very large instruction word architecture. Furthermore, the CPU 1430 can be based on the Von Neuman model or the Harvard model. The CPU 1430 can be a digital signal processor, an FPGA, an ASIC, a PLA, a PLD, or a CPLD. Further, the CPU 1430 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 14, the data processing system 1400 can include that the SB/ICH 1420 is coupled through a system bus to an I/O Bus, a read only memory (ROM) 1456, universal serial bus (USB) port 1464, a flash binary input/output system (BIOS) 1468, and a graphics controller 1458. PCI/PCIe devices can also be coupled to SB/ICH 1488 through a PCI bus 1462.

The PCI devices may include, for example, Ethernet adapters, add-in cards, and PC cards for notebook computers. The Hard disk drive 1460 and CD-ROM 1466 can use, for example, an integrated drive electronics (IDE) or serial advanced technology attachment (SATA) interface. In one implementation the I/O bus can include a super I/O (SIO) device.

Further, the hard disk drive (HDD) 1460 and optical drive 1466 can also be coupled to the SB/ICH 1420 through a system bus. In one implementation, a keyboard 1470, a mouse 1472, a parallel port 1478, and a serial port 1476 can be connected to the system bus through the I/O bus. Other peripherals and devices that can be connected to the SB/ICH 1420 using a mass storage controller such as SATA or PATA, an Ethernet port, an ISA bus, an LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes in battery sizing and chemistry or based on the requirements of the intended back-up load to be powered.

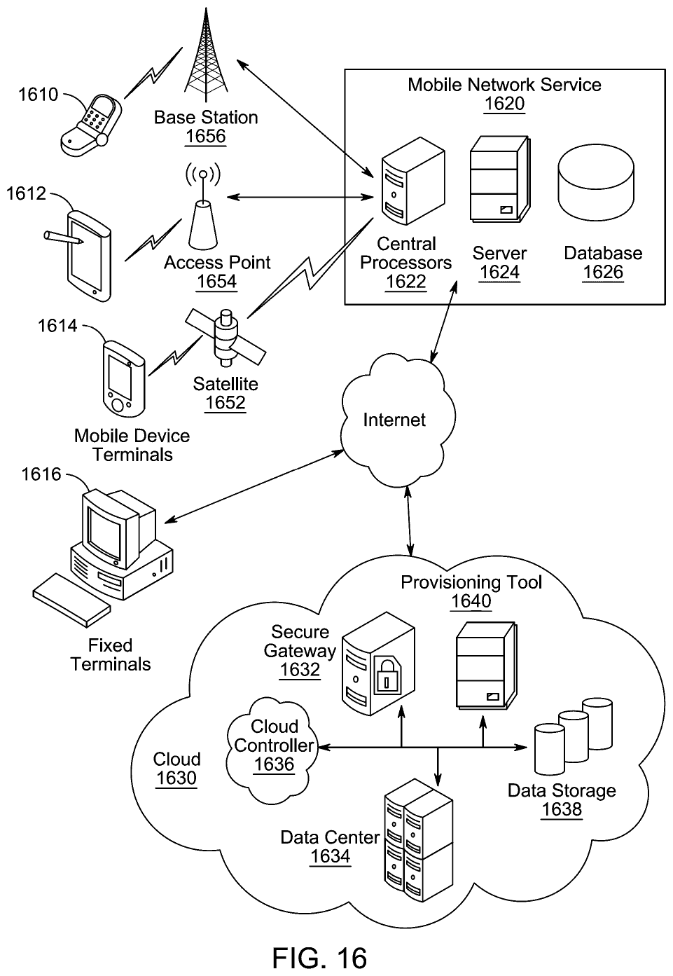

The functions and features described herein may also be executed by various distributed components of a system. For example, one or more processors may execute these system functions, wherein the processors are distributed across multiple components communicating in a network. The distributed components may include one or more clients and server machines, which may share processing, as shown by FIG. 16, in addition to various human interface and communication devices (e.g., display monitors, smart phones, tablets, personal digital assistants (PDAs). More specifically, FIG. 16 illustrates client devices including a smart phone 1611, a tablet 1612, a mobile device terminal 1614 and fixed terminals 1616. These client devices may be commutatively coupled with a mobile network service 1620 via a base station 1656, an access point 1654, a satellite 1652 or via an internet connection. The mobile network service 1620 may comprise central processors 1622, a server 1624 and a database 1626. The fixed terminals 1616 and the mobile network service 1620 may be commutatively coupled via an internet connection to functions in cloud 1630 that may comprise a security gateway 1632, a data center 1634, a cloud controller 1636, a data storage 1638 and a provisioning tool 1640. The network may be a private network, such as the LAN or the WAN, or maybe the public network, such as the Internet. Input to the system may be received via direct user input and received remotely either in real-time or as a batch process. Additionally, some implementations may be performed on modules or hardware not identical to those described. Accordingly, other implementations are within the scope that may be disclosed.

The above-described hardware description is a non-limiting example of corresponding structure for performing the functionality described herein.

Numerous modifications and variations of the present disclosure are possible considering the above teachings. It is therefore to be understood that the invention may be practiced otherwise than as specifically described herein.

1. A method of constructing a three-dimensional (3D) model of an urban area, comprising:
obtaining a plurality of video frames from a calibrated multi-camera setup covering a 360-degree view mounted on a vehicle, wherein the plurality of video frames are obtained while the vehicle is traveling through the urban area;
splitting, by processing circuitry, the plurality of video frames into a plurality of 3D parts containing a subset of the plurality of video frames;
preprocessing, by the processing circuitry, the subset of the plurality of video frames of each part of the plurality of parts to obtain a calculated information;
constructing, by the processing circuitry, a 3D representation of each part of the plurality of parts based on the calculated information to obtain a plurality of local 3D reconstructed scene intervals;
stitching and filtering, by the processing circuitry, the plurality of local 3D reconstructed scene intervals to construct a 3D digital twin; and
periodically transmitting and storing the digital twin in a database as a 3D model of the urban area.

2. The method of claim 1, wherein the preprocessing further comprises:
identifying, by the processing circuitry, a plurality of objects to be excluded based on a scene reconstruction framework having a prompt-based video segmentation module, an object detection model, and a tracking foundation model from the subset of the plurality of video frames of each part of the plurality of parts; and
removing, by the processing circuitry, the plurality of objects to be excluded and reconstructing the plurality of video frames based on a video inpainting model.

3. The method of claim 1, wherein the preprocessing further comprises:
estimating, by the processing circuitry, camera poses, and a point cloud based on a structure-from-motion (SfM) approach, wherein distinctive features, including corners or edges, are extracted from each image;
training, by the processing circuitry, a view synthesis model with the camera poses and the point cloud; and
obtaining the calculated information based on the view synthesis model.

4. The method of claim 1, wherein the constructing further comprises refining, by the processing circuitry, the plurality of local 3D reconstructed scene intervals based on a bundle adjustment technique, wherein the bundle adjustment technique is a non-linear least-squares optimization.

5. The method of claim 1, wherein the stitching and filtering further comprises:
converting, by the processing circuitry, a local coordinate of each local 3D reconstructed scene interval of the plurality of local 3D reconstructed scene intervals represented by an ellipsoid based on a Kabsch-Umeyama algorithm to obtain a structure-from-motion (SfM) coordinate; and
calculating, by the processing circuitry, a hyperplane between two adjacent local 3D reconstructed scene intervals of the plurality of local 3D reconstructed scene intervals.

6. The method of claim 5, wherein the stitching and filtering further comprises filtering, by the processing circuitry, a noise based on the hyperplane to obtain a plurality of filtered local 3D reconstructed scene intervals.

7. The method of claim 6, wherein the stitching and filtering further comprises stitching, by the processing circuitry, the plurality of filtered local 3D reconstructed scene intervals to construct the 3D city street scene.

8. The method of claim 3, wherein the splitting further comprises:
dividing the plurality of video frames into one timestamp to create the plurality of parts of equal-size; and
training, in a parallel processing pipeline, models based on Gaussian Splitting (GS) and neural radiance field (NeRF) with normalized said camera poses and a point cloud from SfM, supervised by segmentation masks and depth maps.

9. The method of claim 3, wherein the stitching further comprises:
merging and aligning local Gaussian point cloud scenes; and
building a large-scale level digital twin of the 3D city street scene, leveraging transforms that are calculated via intersections of the camera poses over a shared timestamp for neighboring of the 3D parts.

10. The method of claim 1, further comprising exporting the constructed 3D model of the urban area to a virtual reality application.

11. A system for constructing a three-dimensional (3D) model of an urban area, comprising:
a calibrated multi-camera setup covering a 360-degree view mounted on a vehicle configured to obtain a plurality of video frames while the vehicle is traveling through the urban area; and
a processing circuitry configured to
split, by processing circuitry, the plurality of video frames into a plurality of 3D parts containing a subset of the plurality of video frames;
preprocess the subset of the plurality of video frames of each part of the plurality of parts to obtain a calculated information;
construct a 3D representation of each part of the plurality of parts based on the calculated information to obtain a plurality of local 3D reconstructed scene intervals;
stitch and filter the plurality of local 3D reconstructed scene intervals to construct a 3D digital twin; and
periodically transmit and store the digital twin in a database as a 3D model of the urban area.

12. The system of claim 11, wherein the processing circuitry is further configured to:
identify a plurality of objects to be excluded based on a scene reconstruction framework having a prompt-based video segmentation module, an object detection model, and a tracking foundation model from the subset of the plurality of video frames of each part of the plurality of parts; and
remove the plurality of objects to be excluded and reconstructing the plurality of video frames based on a video inpainting model.

13. The system of claim 11, wherein the processing circuitry is further configured to:
estimate camera poses and a point cloud based on a structure-from-motion (SfM) approach, wherein distinctive features, including corners or edges, are extracted from each image;
train a view synthesis model with the camera poses and the point cloud; and
obtain the calculated information based on the view synthesis model.

14. The system of claim 11, wherein the processing circuitry is further configured to:
refine the plurality of local 3D reconstructed scene intervals based on a bundle adjustment technique, wherein the bundle adjustment technique is a non-linear least-squares optimization.

15. The system of claim 11, wherein the processing circuitry is further configured to:
convert a local coordinate of each local 3D reconstructed scene interval of the plurality of local 3D reconstructed scene intervals represented by an ellipsoid based on a Kabsch-Umeyama algorithm to obtain a structure-from-motion (SfM) coordinate; and
calculate a hyperplane between two adjacent local 3D reconstructed scene intervals of the plurality of local 3D reconstructed scene intervals.

16. The system of claim 15, wherein the processing circuitry is further configured to:
filter a noise based on the hyperplane to obtain a plurality of filtered local 3D reconstructed scene intervals.

17. The system of claim 16, wherein the processing circuitry is further configured to:
stitch the plurality of filtered local 3D reconstructed scene intervals to construct the 3D city street scene.

18. The system of claim 13, wherein the processing circuitry is further configured to:
divide the plurality of video frames into one timestamp to create the plurality of parts of equal-size; and
wherein the processing circuitry is a GPU device configured with a parallel processing pipeline to train in parallel models based on Gaussian Splitting (GS) and neural radiance field (NeRF) with normalized said camera poses and a point cloud from SfM, supervised by segmentation masks and depth maps.

19. The system of claim 13, wherein the processing circuitry is further configured to:
merge and align local Gaussian point cloud scenes; and
build a large-scale level digital twin of the 3D city street scene, leveraging transforms that are calculated via intersections of the camera poses over a shared timestamp for neighboring of the 3D parts.

20. The system of claim 11, further comprising a virtual reality application that imports the constructed 3D model of the urban area and uses the 3D model to display a virtual representation of the urban area.
